(19) United States
(12) Patent Application Publication
(10) Pub. No.: US 2025/0111003 A1
(43) Pub. Date: Apr. 3, 2025

(54) METHOD AND SYSTEM FOR IDENTIFYING DARK PATTERNS OVER USER INTERFACE IMPACTING USER HEALTH

(71) Applicant: Samsung Electronics Co., Ltd., Suwon-si (KR)

(72) Inventor: Akash YADAV, Indore (IN)

(21) Appl. No.: 18/431,402

(22) Filed: Feb. 2, 2024

Related U.S. Application Data
(63) Continuation of application No. PCT/KR2023/019704, filed on Dec. 1, 2023.

(30) Foreign Application Priority Data
Sep. 29, 2023 (IN) 202311065694

(51) Int. Cl. G06F 16/957; G06F 3/04842; G06F 3/0485; G06F 9/451; G06F 11/34; G06F 40/30

(52) U.S. Cl. CPC G06F 16/9577; G06F 3/04842; G06F 3/0485; G06F 9/451; G06F 11/3438; G06F 40/30

(57) ABSTRACT

A method for identifying one or more patterns within a screen layout of an electronic device having the negative impact on the user of the electronic device is provided. The method includes detecting at least one of one or more user interface/user experience (UI/UX) elements within the screen layout, and one or more characteristics associated with the at least one of one or more UI/UX elements. The method includes identifying, based on the one or more UI-related parameters, the one or more patterns associated with at least one of the one or more detected UI/UX elements within the screen layout having the negative impact on the user based on the one or more predefined rules. The method includes determining one or more UI elements that have to be placed on top of at least one of the one or more identified negative UI/UX within the screen layout.

### CROSS-REFERENCE TO RELATED APPLICATION(S)

This application is a continuation application, claiming priority under § 365 (c), of an International application No. PCT/KR2023/019704, filed on Dec. 1, 2023, which is based on and claims the benefit of an Indian Patent Application number 202311065694, filed on Sep. 29, 2023, in the Indian Intellectual Property Office, the disclosure of which is incorporated by reference herein in its entirety.

### FIELD OF THE INVENTION

The disclosure relates to the field of electronic devices. More particularly, the disclosure relates to a method and a system for identifying dark patterns over a user interface (UI) impacting user health.

### BACKGROUND

Dark patterns are design strategies used in user interfaces of electronic devices (e.g., smartphones) to influence or trick people into performing activities that they would not otherwise choose to do. Businesses or websites frequently use the dark patterns to achieve certain aims, such as increasing sales or gathering user data. The dark patterns can take many different forms, such as deceptive images, puzzling language, coercive techniques, purposely highlighting features of a website or service that produce profit, and so forth. In other words, the dark patterns boost conversion and efficiently direct user behavior towards desired activities like purchasing or signing up for a service. That may result in increased conversion rates, which are critical for businesses. Furthermore, by utilizing strategies such as auto-subscriptions or playback features, the dark patterns may keep users more engaged with a website or app, thereby enhancing user retention. As a result, the dark patterns might bring instant money or other advantages for a company, which can be desirable from a financial standpoint in the short term.

FIG. 1 illustrates one or more problem scenarios associated with dark patterns according to the related art.

Referring to FIG. 1, one or more manipulative tactics may include misleading button labels, making it arduous to reverse choices, or employing visual cues like color and shading to direct user attention 11. Certain over-the-top (OTT) media service platforms may conceal an option to sign out to maintain user engagement, and various applications automatically initiate a next episode 12 to retain user involvement. Additionally, the businesses might resort to bait-and-switch strategies 13 to increase user interactions, as exemplified by an operating system (OS) dialog box, which triggers an upgrade when the user attempts to close it.

Despite the evident advantages in terms of user engagement, the dark patterns may adversely affect users' mental well-being by eliciting negative emotions such as fear and anxiety to compel them to undertake specific actions, such as subscribing to emails, continuously watching videos, or making purchases. Furthermore, there are various drawbacks of the dark patterns. For starters, the dark patterns impact user trust, and using the dark patterns might erode user trust. Users who believe that they have been influenced or tricked are less inclined to trust the businesses or return to their platform, which may undermine long-term partnerships. Second, the dark patterns have a poor reputation, and if word gets out that a business utilizes the dark patterns, it may harm the business' brand, resulting in unfavorable news and public reaction. Third, the dark patterns raise legal and ethical concerns, as some dark patterns are unlawful or breach ethical norms, perhaps leading to litigation, penalties, or regulatory action. Fourth, while the dark patterns may provide short-term benefits, they might have long-term negative repercussions such as decreased customer satisfaction and greater costs. Currently, there is no defined method for furnishing personalized user interface elements designed to counteract these dark patterns and safeguard the well-being of the user.

Thus, it is desired to address the above-mentioned disadvantages or other shortcomings or at least provide a useful alternative for identifying the dark patterns over the UI impacting user health.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and a system for identifying dark patterns over a user interface (UI) impacting user health.

Additional aspects will be set forth in part in the description which follows and, in part, will be apparent from the description, or may be learned by practice of the presented embodiments.

In accordance with an aspect of the disclosure, a method for identifying one or more patterns within a screen layout of an electronic device having a negative impact on a user of the electronic device is provided. The method includes detecting, by an identification module of the electronic device, at least one of one or more user interface (UI) elements and one or more user experience (UX) elements within the screen layout, and one or more characteristics associated with the at least one of one or more UI elements and one or more UX elements. The method further includes identifying, by a Machine Learning (ML) module, based on one or more UI-related parameters, the one or more patterns associated with at least one of one or more detected UI elements and one or more detected UX elements within the screen layout having the negative impact on the user based on one or more predefined rules. The method further includes determining, by a display controller of the electronic device, one or more UI elements that have to be placed on top of at least one of one or more identified negative UI elements and one or more identified negative UX elements within the screen layout.

In accordance with another aspect of the disclosure, an electronic device for identifying the one or more patterns within the screen layout of the electronic device having the negative impact on the user of the electronic device is provided. The electronic device includes a system, where the system includes a dark pattern identifier module coupled with a processor, a memory, and a communicator. The dark pattern identifier module is configured to detect at least one of the one or more UI elements and the one or more UX elements within the screen layout, and the one or more characteristics associated with the at least one of the one or more UI elements and the one or more UX elements. The dark pattern identifier module is further configured to identify based on the one or more UI-related parameters, the one or more patterns associated with at least one of the one or more detected UI elements and the one or more detected UX elements within the screen layout having the negative impact on the user based on the one or more predefined rules. The dark pattern identifier module is further configured to determine the one or more UI elements that have to be placed on top of at least one of the one or more identified negative UI elements and the one or more identified negative UX elements within the screen layout.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates one or more problem scenarios associated with dark patterns according to the related art;

FIG. 2 illustrates a block diagram of an electronic device for identifying one or more patterns within a screen layout of an electronic device having a negative impact on a user of the electronic device, according to an embodiment of the disclosure;

FIG. 3A illustrates a block diagram of an identification module of an electronic device to detect at least one of one or more user interface (UI) elements and one or more user experience (UX) elements within a screen layout, according to an embodiment of the disclosure;

FIG. 3B illustrates one or more scenarios where a platform detector module of an identification module detects platform information on which at least one application of an electronic device is running, according to an embodiment of the disclosure;

FIG. 3C illustrates a scenario where one or more modules of an identification module detect one or more characteristics associated with at least one of one or more UI elements and one or more UX elements, according to an embodiment of the disclosure;

FIG. 4A illustrates a block diagram of a Machine Learning (ML) module of an electronic device to identify one or more patterns associated with at least one of one or more detected UI elements and one or more detected UX elements within a screen layout having a negative impact on a user based on one or more predefined rules, according to an embodiment of the disclosure;

FIG. 4B illustrates a scenario where an interaction graph generator of a ML module generates one or more hierarchical/interaction graphs by utilizing one or more modules of an identification module, according to an embodiment of the disclosure;

FIG. 4C illustrates a scenario where an interaction identifier of a ML module updates one or more generated hierarchical/interaction graphs based on one or more observable modifications and extracted content, according to an embodiment of the disclosure;

FIG. 4D illustrates a scenario where a feature dependencies graph generator of a ML module generates one or more feature dependency graphs between the or more UI elements and one or more UX elements associated with one or more generated interaction graphs to analyze current user behavior, according to an embodiment of the disclosure;

FIG. 4E illustrates a block diagram of a natural language processing (NLP) module of a ML module identifies one or more patterns associated with at least one of one or more detected UI elements and one or more detected UX elements within screen layout having a negative impact on a user, according to an embodiment of the disclosure;

FIG. 4F illustrates a scenario where a spatial analysis module of a ML module identifies one or more patterns associated with at least one of one or more detected UI elements and one or more detected UX elements within a screen layout having a negative impact on a user, according to an embodiment of the disclosure;

FIG. 5 illustrates a block diagram of a display controller module of an electronic device to determine one or more UI elements that have to be placed on top of at least one of one or more identified negative UI elements and one or more identified negative UX elements within a screen layout according to an embodiment of the disclosure;

FIG. 6 illustrates a comparison scenario between existing system and disclosed system to identify one or more patterns within a screen layout of an electronic device having a negative impact on a user of the electronic device, according to an embodiment of the disclosure; and

FIG. 7 is a flow diagram illustrating a method for identifying one or more patterns within a screen layout of an electronic device having a negative impact on a user of the electronic device, according to an embodiment of the disclosure.

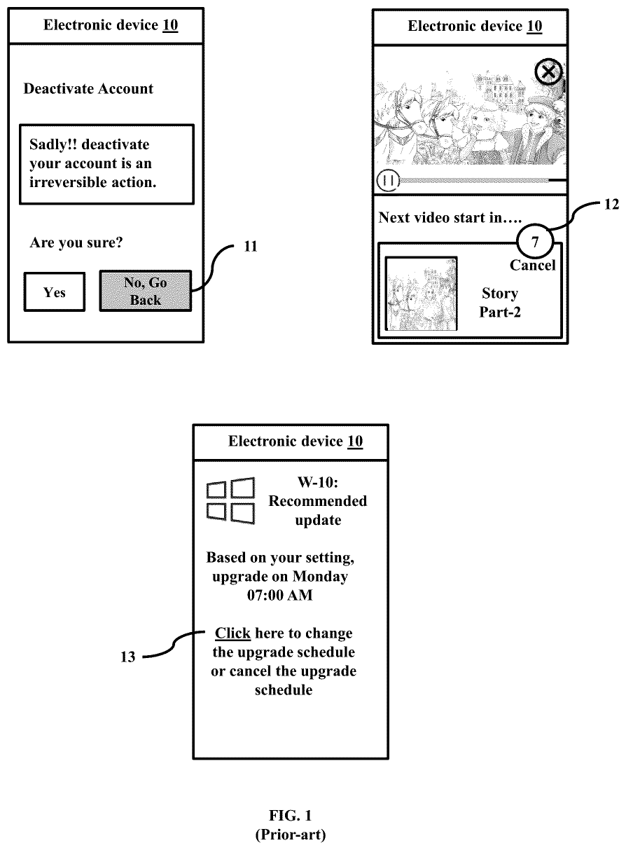

Throughout the drawings, it should be noted that like reference numbers are used to depict the same or similar elements, features, and structures.

### DETAILED DESCRIPTION OF FIGURES

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in one embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Also, the various embodiments described herein are not necessarily mutually exclusive, as some embodiments may be combined with one or more other embodiments to form new embodiments. The term “or” as used herein, refers to a non-exclusive or unless otherwise indicated. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents, and substitutes in addition to those which are particularly set out in the accompanying drawings. Although the terms first, second, and the like, may be used herein to describe various elements, these elements should not be limited by these terms. These terms are generally only used to distinguish one element from another.

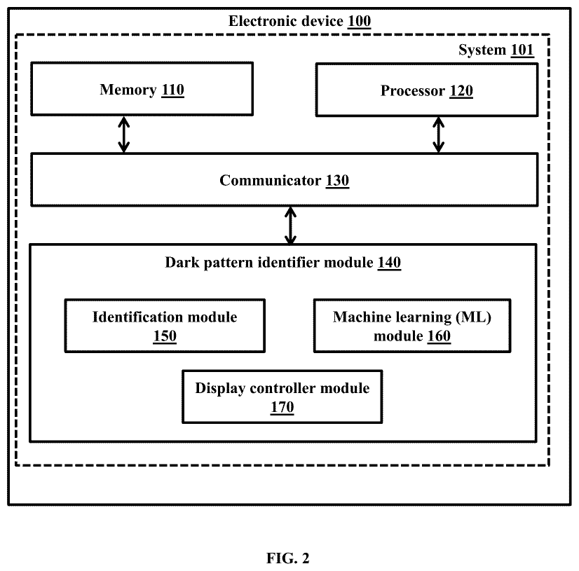

Referring now to the drawings, and more particularly to FIGS. 2, 3A to 3C, 4A to 4F, and 5 to 7, where similar reference characters denote corresponding features consistently throughout the figures, there are shown preferred embodiments.

FIG. 2 illustrates a block diagram of an electronic device for identifying one or more patterns within a screen layout of the electronic device having a negative impact on a user of the electronic device, according to an embodiment of the disclosure. Examples of the electronic device include, but are not limited to, a smartphone, a tablet computer, a Personal Digital Assistance (PDA), an Internet of Things (IoT) device, a wearable device, and the like.

Referring to FIG. 2, an electronic device 100 comprises a system 101. The system 101 may include a memory 110, a processor 120, a communicator 130, and a dark pattern identifier module 140. In one or more embodiments, the system 101 may associated with one or more electronic device or a separate module.

In an embodiment, the memory 110 stores instructions to be executed by the processor 120 for identifying the one or more patterns (e.g., dark patterns) within the screen layout of the electronic device 100 having the negative impact on the user of the electronic device 100, as discussed throughout the disclosure. The dark patterns are user interface design decisions that convince the users to perform actions they would not have made otherwise. They may be deceiving and have undesirable consequences for the user, such as unintentional purchases or the revealing of personal information. The memory 110 may include non-volatile storage elements. Examples of such non-volatile storage elements may include magnetic hard disks, optical disks, floppy disks, flash memories, or forms of electrically programmable read only memories (EPROMs) or electrically erasable and programmable ROM (EEPROM) memories. In addition, the memory 110 may, in some examples, be considered a non-transitory storage medium. The term “non-transitory” may indicate that the storage medium is not embodied in a carrier wave or a propagated signal. However, the term “non-transitory” should not be interpreted that the memory 110 is non-movable. In some examples, the memory 110 may be configured to store larger amounts of information than the memory. In certain examples, a non-transitory storage medium may store data that may, over time, change (e.g., in Random Access Memory (RAM) or cache). The memory 110 may be an internal storage unit, or it may be an external storage unit of the electronic device 100, a cloud storage, or any other type of external storage.

The processor 120 communicates with the memory 110, the communicator 130, and the dark pattern identifier module 140. The processor 120 is configured to execute instructions stored in the memory 110 and to perform various processes for identifying the one or more patterns (e.g., dark patterns) within the screen layout of the electronic device 100 having the negative impact on the user of the electronic device 100, as discussed throughout the disclosure. The processor 120 may include one or a plurality of processors, maybe a general-purpose processor, such as a central processing unit (CPU), an application processor (AP), and the like, a graphics-only processing unit such as a graphics processing unit (GPU), a visual processing unit (VPU), and/or an Artificial intelligence (AI) dedicated processor such as a neural processing unit (NPU).

The communicator 130 is configured for communicating internally between internal hardware components and with external devices (e.g., server) via one or more networks (e.g., radio technology). The communicator 130 includes an electronic circuit specific to a standard that enables wired or wireless communication.

The dark pattern identifier module 140 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one or more embodiments, the dark pattern identifier module 140 includes an identification module 150, a Machine Learning (ML) module 160, and a display controller module 170.

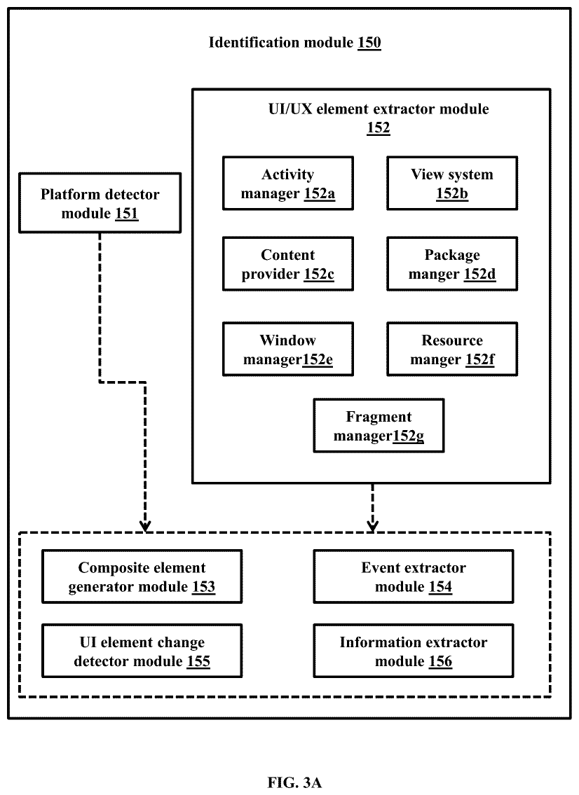

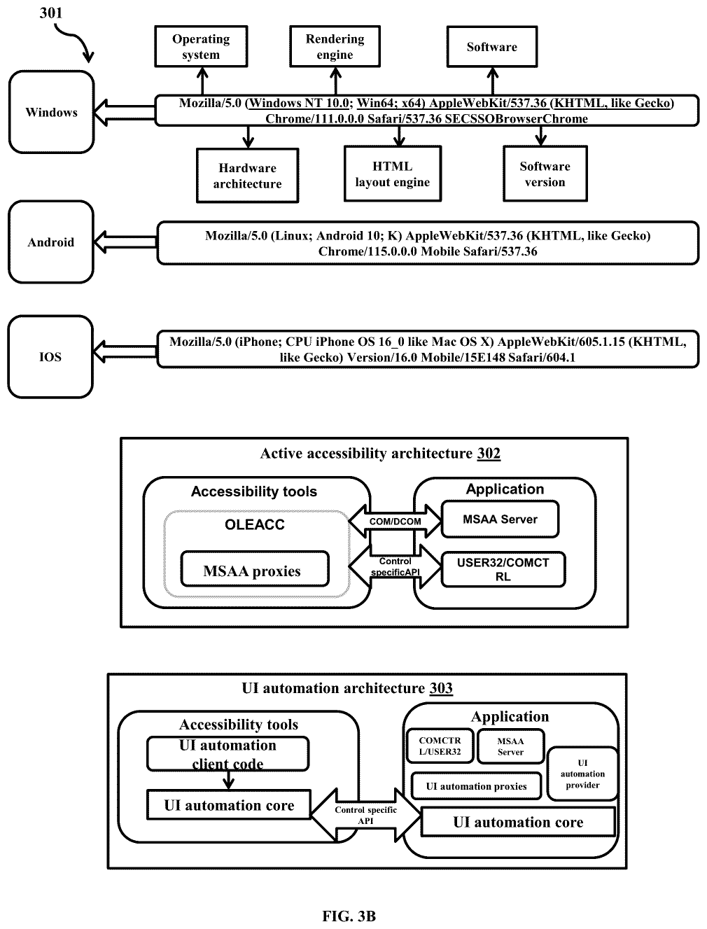

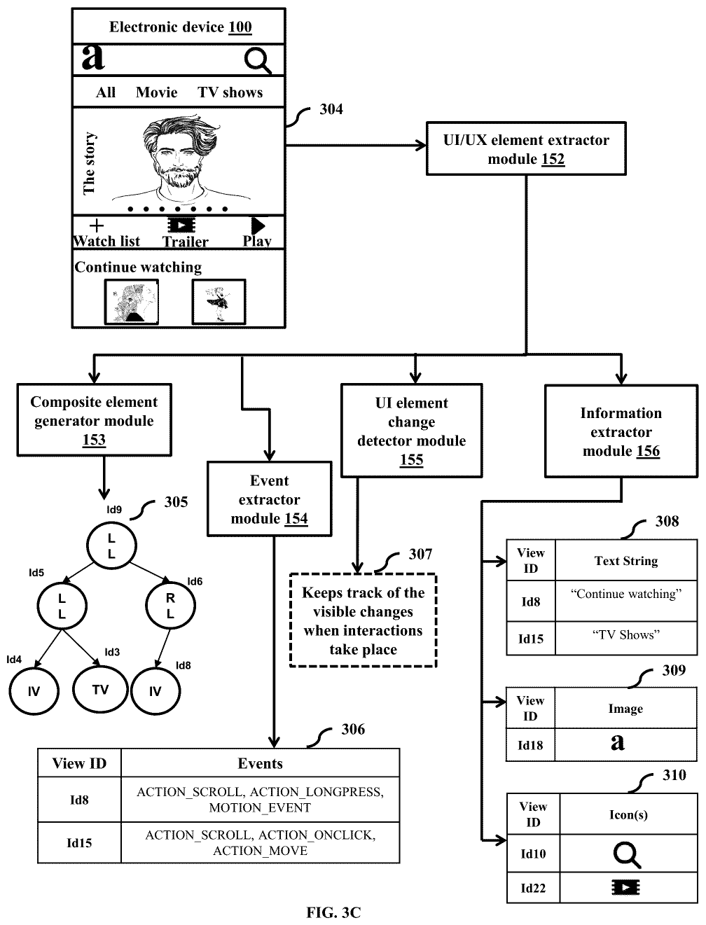

In one or more embodiments, the identification module 150 is configured to detect at least one of one or more user interface (UI) elements and one or more user experience (UX) elements within the screen layout, and one or more characteristics associated with the at least one of one or more UI elements (e.g., home screen icons, touch screen keyboard, and the like) and one or more UX elements (e.g., smartphone notification, navigation application, and the like), as described in conjunction with FIGS. 3A to 3C, 6, and 7. The one or more UI elements refer to visual components that users interact with to navigate and interact with a digital product or application of the electronic device 100. The one or more UX elements refer to the overall experience and satisfaction that users have while interacting with the digital product or application of the electronic device 100.

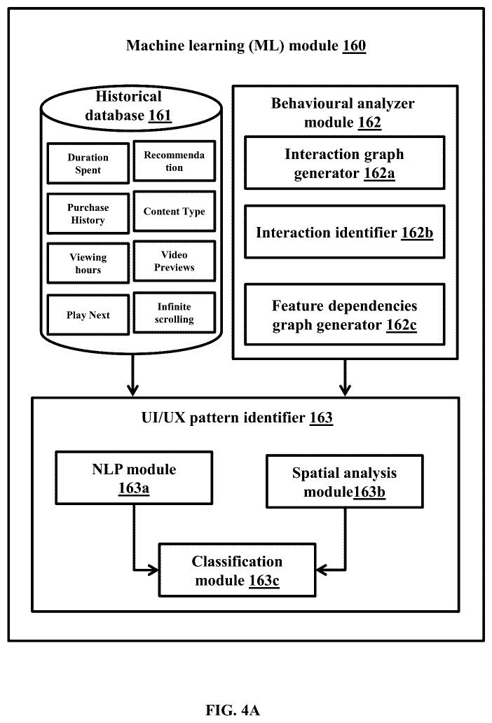

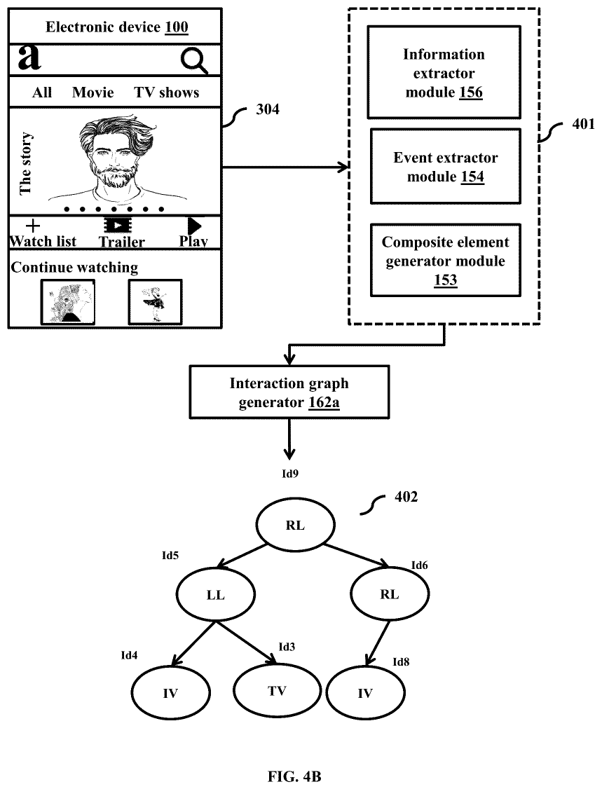

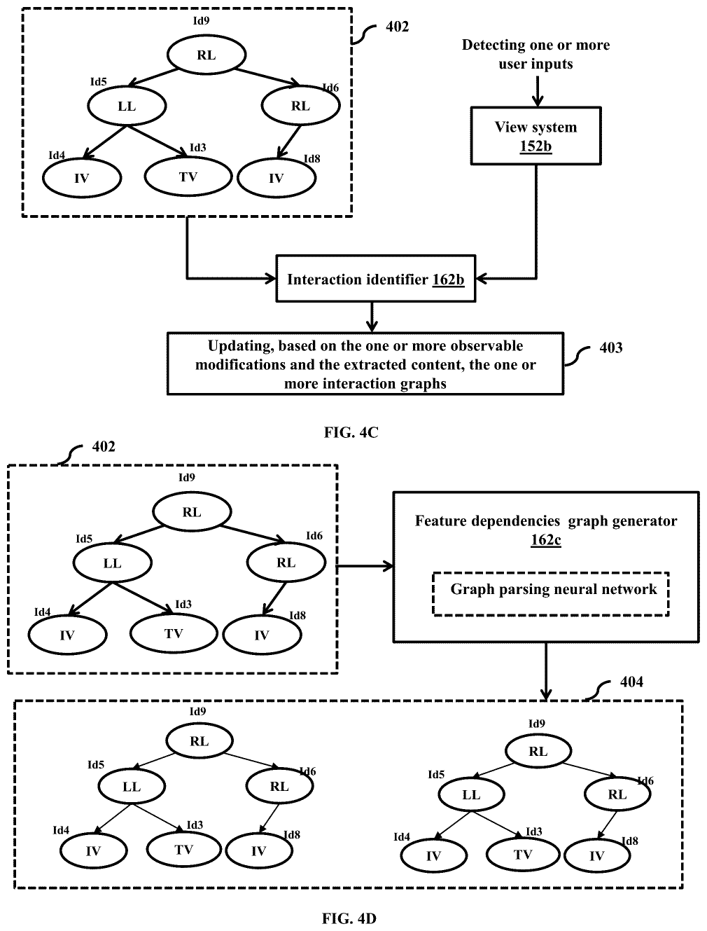

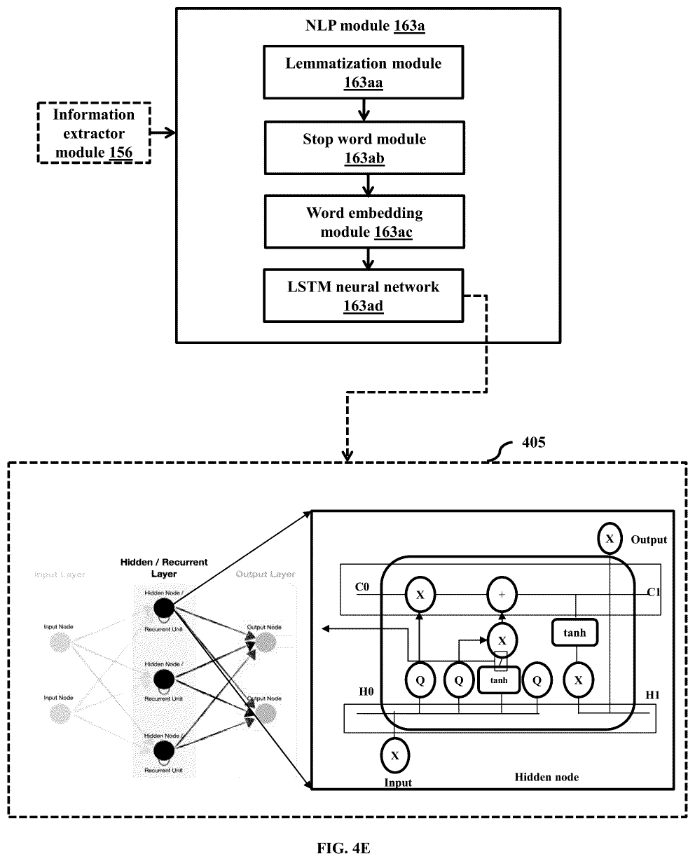

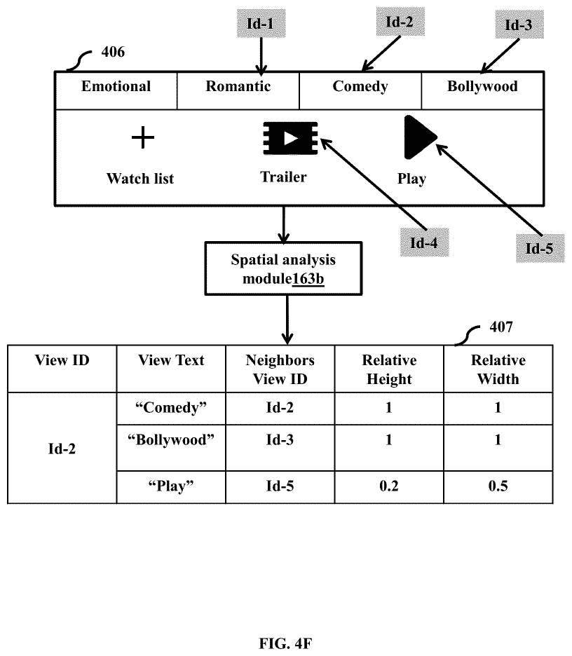

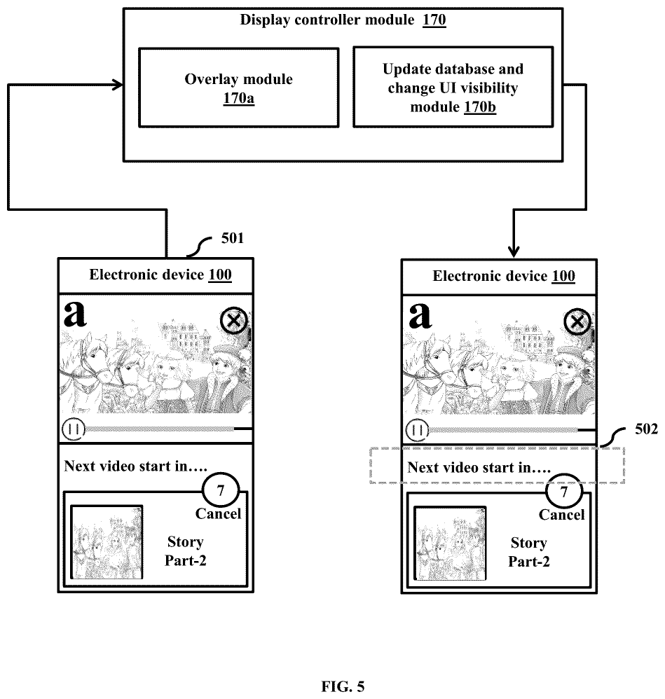

In one or more embodiments, the ML module 160 is configured to identify, based on one or more UI-related parameters, the one or more patterns associated with at least one of one or more detected UI elements and one or more detected UX elements within the screen layout having the negative impact on the user based on one or more predefined rules, as described in conjunction with FIGS. 4A to 4F, 6, and 7. The one or more UI-related parameters include, for example, at least one of a historical behavioral pattern of the user and a current behavioral pattern of the user associated with a single or multi-program scenario associated with the electronic device 100. The multi-program scenario includes one or more programs running on cross-platforms.

In one example, for the historical behavioral pattern of the user associated with the single or multi-program, consider a scenario where the user routinely uses a laptop for both professional and personal tasks. The user may launch a word processing program, a web browser, and a music streaming application on the laptop over the last year. The user may often work during a day, move between projects, peruse the web browser, and unwind in an evening by streaming music. In another example, for the current behavioral pattern of the user associated with the single or multi-program, consider a scenario where the user may work on the word processing program in the laptop and receive a notification regarding an important email in a smartphone, which may drive the user to use the smartphone to answer quickly. Later in the day, the user may continue to work on the laptop, but also often connect with coworkers via a messaging application of the smartphone.

In one or more embodiments, the one or more detected UI elements and the one or more detected UX elements, along with the one or more characteristics, are dynamically or statically displayed over the UI of an active program or a background program associated with the electronic device 100. In one example, when the user opens a messaging application on the electronic device 100, the one or more detected UX elements like chat boxes and buttons for sending messages are dynamic and adapt as the user may use the messaging application. In another example, one or more icons on a home screen of the electronic device 100 remain in the same area and seem the same (static) regardless of how the user uses the electronic device 100. In one or more embodiments, the one or more characteristics associated with the at least one of one or more UI elements and one or more UX elements include at least one of feature information, position information, and functionality information. The feature information refers to one or more details or attributes of the one or more UI or UX elements. For example, the UI element might have feature information such as color, size, or shape. The UX element might have feature information related to the functionality it provides, such as a search bar or a feedback form. The position information relates to a placement or location of the one or more UI or UX elements within the interface. The position information includes factors like the arrangement, alignment, and hierarchy of elements. For instance, the UI elements may be positioned at the top of a webpage for easy access, while the UX elements like navigation menus may be strategically placed for user convenience. The functionality information pertains to a purpose or behavior of the one or more UI or UX elements, which describes how they work and what actions they enable users to perform. For example, the UI element like a button may have functionality information indicating that it triggers a specific action when clicked. The UX element like a progress indicator may provide functionality information by showing the status of an ongoing process.

In one or more embodiments, the display controller module 170 is configured to determine one or more UI elements that have to be placed on top of at least one of one or more identified negative UI elements and one or more identified negative UX elements within the screen layout, as described in conjunction with FIGS. 5 to 7. The display controller module 170 is further configured to receive a feedback from the user in response to the determining of the one or more UI elements that have to be placed on top of the at least one of one or more identified negative UI elements and one or more identified negative UX elements. The display controller module 170 is further configured to update, using a reinforcement learning technique, one or more parameters associated with the identification module 150 based on the feedback. The display controller module 170 is further configured to personalize UI/UX elements based on at least one of one or more identified negative UI elements, one or more identified negative UX elements and the one or more updated parameters.

In one or more embodiments, the display controller module 170 is configured to accept user inputs and is made of a Liquid Crystal Display (LCD), a Light Emitting Diode (LED), an Organic Light Emitting Diode (OLED), or another type of display. The user inputs may include but are not limited to touch, swipe, drag, gesture, and so on.

A function associated with the various components of the electronic device 100 may be performed through the non-volatile memory, the volatile memory, and the processor 120. One or a plurality of processors controls the processing of the input data in accordance with a predefined operating rule or AI model stored in the non-volatile memory and the volatile memory to perform various processes for identifying the one or more patterns (e.g., dark patterns) within the screen layout of the electronic device 100 having the negative impact on the user of the electronic device 100. The predefined operating rule or AI model is provided through training or learning. Being provided through learning means that, by applying a learning mechanism to a plurality of learning data, a predefined operating rule or AI model of the desired characteristic is made. The learning may be performed in a device itself in which AI according to an embodiment is performed, and/or may be implemented through a separate server/system. The learning mechanism is a method for training a predetermined target device (i.e., a robot) using a plurality of learning data to cause, allow, or control the target device to decide or predict. Examples of learning algorithms include, but are not limited to, supervised learning, unsupervised learning, semi-supervised learning, or reinforcement learning.

The AI model may consist of a plurality of neural network layers. Each layer has a plurality of weight values and performs a layer operation through a calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

Although FIG. 2 shows various hardware components of the electronic device 100, but it is to be understood that other embodiments are not limited thereon. In other embodiments, the electronic device 100 may include less or more number of components. Further, the labels or names of the components are used only for illustrative purposes and do not limit the scope of the disclosure. One or more components may be combined to perform the same or substantially similar functions to identify the one or more patterns (e.g., dark patterns) within the screen layout of the electronic device 100 having the negative impact on the user of the electronic device 100.

FIG. 3A illustrates a block diagram of the identification module of an electronic device to detect at least one of one or more UI elements and one or more UX elements within a screen layout, according to an embodiment of the disclosure.

Referring to FIG. 3A, the identification module 150 may include a platform detector module 151, a UI/UX element extractor module 152, a composite element generator module 153, an event extractor module 154, a UI element change detector module 155, and an information extractor module 156.

In one or more embodiments, the platform detector module 151 is configured to detect, using at least one of a user agent string and system application programming interfaces (APIs), platform information on which at least one application of the electronic device 100 is running, as described in conjunction with FIG. 3B. The platform information includes a type of operating system (OS), a version of the OS, and a hardware architecture.

In one or more embodiments, the UI/UX element extractor module 152 is configured to detect, by utilizing one or more application framework modules associated with the electronic device 100, at least one of the one or more UI elements and the one or more UX elements within the screen layout (e.g., website interface, installed application interface, browser interface, and the like). The one or more application framework modules may include an activity manager 152a, a view system 152b, a content provider 152c, a package manager 152d, a window manager 152e, a resource manager 152f, and a fragment manager 152g. The one or more application framework modules are configured to perform one or more operations to detect at least one of the one or more UI elements and the one or more UX elements within the screen layout, which are given below.

The activity manager 152a is configured to identify one or more current activities and states (e.g., starting, running, paused, stopped, destroyed, and the like) associated with one or more applications (e.g., video application, social media application, and the like) of the electronic device 100. Additionally, the activity manager 152a is configured to manage a lifecycle of one or more current activities and maintain one or more stacks of activities. Additionally, the activity manager 152a is configured to manage one or more background services associated with the electronic device 100. The view system 152b is configured to generate a layout that includes one or more image views and one or more text views associated with the one or more applications of the electronic device 100. Additionally, the view system 152b is configured to manage one or more view properties of the layout and handle all input events (e.g., click, move, touch, and the like). The content provider 152c is configured to extract data from the one or more applications of the electronic device 100, manage access to a central repository of data, and manage a standard interface that connects data in one process/application with code running in another process/application.

The package manager 152d is configured to get package information of the one or more applications running on the screen layout, for example, a window screen associated with the electronic device 100. Additionally, the package manager 152d is configured to manage the installation/removal/updating of the one or more applications. The window manager 152e is configured to identify a position and appearance of a current window on the screen layout. Additionally, the window manager 152e is configured to manage an order list of windows and one or more activities of the window that are used to display its content on the screen layout. The resource manager 152f is configured to determine and manage one or more resources that one or more applications are using. The fragment manager 152g is configured to add/remove/replace one or more fragments of the one or more applications. Additionally, the fragment manager 152g is configured to provide a notification when a change occurs in the one or more fragments.

In one or more embodiments, the UI/UX element extractor module 152 is configured to provide one or more UI controls that are combined and used to construct the whole graphical user interface (GUI) of programmers. Input controls allow the user to interact with the GUI. Example of the one or more UI controls may include, but are not limited to, a text view, a button, an edit text, an image button, a toggle button, a check box, a progress bar, a spinner, a seek bar, a time picker, an alert dialog, and a date picker.

In one or more embodiments, the composite element generator module 153 is configured to generate, by utilizing the one or more application framework modules, a hierarchical graph associated with the at least one of one or more UI elements and one or more UX elements, as described in conjunction with FIG. 3C.

In one or more embodiments, the event extractor module 154 is configured to map, upon detecting one or more user interactions, one or more events with the at least one of one or more UI elements and one or more UX elements by utilizing one or more application framework modules, as described in conjunction with FIG. 3C. The one or more events include, for example, a scroll event, a long press event, a short press event, and a click event.

In one or more embodiments, the UI element change detector module 155 is configured to monitor, upon detecting the one or more user interactions, one or more observable modifications associated with the at least one of one or more UI elements and one or more UX elements, as described in conjunction with FIG. 3C. In other words, the UI element change detector module 155 is configured to determine if any visible change (e.g., fragment creation) occurs in at least one of one or more UI elements and one or more UX elements upon the detection of one or more user interactions and one or more observable modifications.

In one or more embodiments, the information extractor module 156 is configured to extract content associated with the at least one of one or more UI elements and one or more UX elements, as described in conjunction with FIG. 3C. The content may include, for example, at least one of text information, image information, and icon information.

FIG. 3B illustrates one or more scenarios where a platform detector module of the identification module detects platform information on which at least one application of an electronic device is running, according to an embodiment of the disclosure.

Referring to FIG. 3B, the platform detector module 151 is configured to detect the at least one of one or more UI elements and one or more UX elements from the screen layout depending upon a platform on which a program/application is running, a system architecture, an application running, a layout engine, and the like. As described below, there are two methods used to determine the platform.

The user agent string 301: It acts as an intermediary between a user and a server, which allows the user to interact with the server via a web browser or other client application. It is identified by a unique user agent string, which is sent as part of a hypertext transfer protocol (HTTP) request header when the user accesses a web page. The user agent string includes information about a client device, such as operating system (OS) information (e.g., Windows®, Android®, iOS®, and the like), hardware architecture information, rendering engine information, layout engine information, software information, and software version information.

The system API calls: Some application programming interfaces (APIs) enable developers to programmatically determine the platform. As an example, consider a API system. The getProperty( ) method determines the current system properties such as the OS and an architecture of the OS by utilizing one or more keys, for example, as shown in Table 1 below. Different ways of identifying UI/UX elements are used depending on the OS.

TABLE 1

| Key | Description of associated value |
|---|---|
| os.name | OS name |
| os.arch | OS architecture |
| os.version | OS version |
| java.version | Java runtime environment version |

The platform detector module 151 is configured to use, for example, a user interface automation (UIA) API to identify the at least one of one or more UI elements and one or more UX elements in an OS. This API allows you to programmatically access and interact with one or more UI elements of programmers. For example, active accessibility architecture 302 and UI automation architecture 303 are two technologies that make up the automation API. The active accessibility architecture 302 and UI automation architecture 303 may expose a UI object model as a hierarchical tree, rooted at the electronic device 100 (e.g., desktop). Additionally, the active accessibility architecture 302 may represent individual UI elements as accessible objects and the UI automation architecture 303 may represent individual UI elements as automation elements. As described below, the active accessibility architecture 302 may include one or more entities Win-Events and OLEACC.

Win-Events: An event system that enables servers (e.g., Microsoft active accessibility (MSAA) server) to notify clients when the accessible objects change.

OLEACC: The run-time, dynamic-link library (DLL) that provides the active accessibility API and an accessibility system framework. The OLEACC implements proxy objects that provide default accessibility information for standard UI elements, including user controls, user menus, and common controls.

Accessible object: A logical UI element (such as a button) that is represented by an accessible component object model (COM) interface and an integer child identifier (ChildID).

Further, a UI automation core component (UIAutomationCore.dll) is loaded into both accessibility tools and applications processes associated with the active accessibility architecture 302. The UI automation core component is configured to manage cross-process communication, provides higher-level services such as searching for elements by property values, and enables bulk fetching or caching of properties. Furthermore, the active accessibility architecture 302 may include proxy objects (e.g., UI automation proxies) that provide UI information about standard UI elements such as user controls, user menus, and common controls.

FIG. 3C illustrates a scenario where one or more modules of identification module detect one or more characteristics associated with at least one of one or more UI elements and one or more UX elements, according to an embodiment of the disclosure.

Referring to FIG. 3C, the UI/UX element extractor module 152 is configured to detect/extract the at least one of one or more UI elements and one or more UX elements within the screen layout by utilizing the one or more application framework modules (e.g., view system 152b). For example, in Android-supported electronic device 100, the UI/UX element extractor module 152 is configured to utilize a UIautoviewer, which is a GUI tool to scan and analyze the one or more UI elements (e.g., search icon, watchlist icon, trailer icon, play icon, and the like) and one or more UI controls (e.g., button, text view, and the like) of an application 304 (e.g., video application), displayed on the screen layout of the electronic device 100.

In one or more embodiments, the UI/UX element extractor module 152 is platform-dependent, which means the functionality of the UI/UX element extractor module 152 differs depending on the technology stack being utilized. For example, if the user works with Android technology, the UI/UX element extractor module 152 is configured to determine information associated with the screen layout, using linear layouts, or detecting text views. These strategies may assist the UI/UX element extractor module 152 to extract the information associated with the screen layout and extract specific UI/UX elements.

In one or more embodiments, the UI/UX element extractor module 152 is configured to determine layout hierarchy information and property information of individual UI elements that are displayed on the screen layout of the electronic device 100 and share this information with the composite element generator module 153, the event extractor module 154, the UI element change detector module 155, and the information extractor module 156 for further processing, as described below.

In one or more embodiments, the composite element generator module 153 is configured to utilize the one or more application framework modules (e.g., view system 152b) to generate the hierarchical graph 305 associated with the at least one of one or more UI elements and one or more UX elements. The view system 152b may include two primary types of extracted views such as a view and a view group. The view is essentially one or more building blocks of the UI, which may occupy one or more rectangular areas on the screen layout. They serve the crucial functions of both rendering what users see on the screen and handling user interactions, such as taps and swipes. On the other hand, the view group is a subclass of the view. Unlike the view, the view group has a unique capability to contain other views within them. Think of them as containers that hold various UI elements, like buttons or text views.

In one or more embodiments, the composite element generator module 153 is configured to generate a structured representation of the UI. This representation includes the hierarchical graph 305, where each UI/UX element is linked to its parent view. This hierarchical, layer-wise graph provides a comprehensive understanding of how different UI elements are organized and layered on the screen layout, where each UI comprises a unique view identity (e.g., id-4 for “image view (IV)”, id-3 for “text view (TV)”, and the like).

In one or more embodiments, the event extractor module 154 is configured to map one or more user interactions 306, MOTION_EVENT, and ACTION_MOVE events, to specific UI elements. It essentially connects user actions with the corresponding parts of the UI, facilitating responsive interactions. For example, consider a scenario where the user may utilize the video application. When the user swipes a finger over the screen layout to examine a watch history, the event extractor module 154 is configured to create the MOTION_EVENT and ACTION_MOVE events and map the created events to the specific UI elements involved, such as the list of movies. This connection allows the video application to reply instantly by smoothly scrolling through watch history and guarantees that actions on the screen layout communicate with appropriate sections of the mobile banking application's UI.

In one or more embodiments, the UI element change detector module 155 is configured to monitor, upon detecting the one or more user interactions, one or more observable modifications (e.g., visual state change: “loading activity”, “pause activity”, “start activity” “new fragment is created”, and the like) 307 associated with the at least one of one or more UI elements and one or more UX elements. For example, consider a scenario where the user may launch the video application, and the video application begins populating feed with popular videos. The UI element change detector module 155 is configured to monitor continually on visual state of each UI element. As videos are loaded into the screen layout, the UI element change detector module 155 is configured to detect a transition from a loading spinner to a list of videos. It also keeps track of when the user opens a new video or comment area. This real-time tracking assists the video application in understanding precisely when and how the UI element changes occur, guaranteeing a seamless and responsive user experience.

In one or more embodiments, the information extractor module 156 is configured to extract content 308, 309, and 310 associated with the at least one of one or more UI elements and one or more UX elements. For example, consider a scenario where the user may launch the video application, the information extractor module 156 is configured to collect information from various UI elements. The information extractor module 156 within the video application employs different methods depending on the platform (e.g., iOS or Android) and the screen layout to extract crucial UI/UX elements. For instance, information extractor module 156 might inspect the layout to find elements like “the story” (TextViews) and other icons (e.g., watch list). Once the information extractor module 156 identifies these UI elements, the information extractor module 156 is configured to extract them as separate data (e.g., text extraction 308, image extraction 309, icon extraction 310, and the like).

FIG. 4A illustrates a block diagram of a ML module of an electronic device to identify one or more patterns associated with at least one of one or more detected UI elements and one or more detected UX elements within a screen layout having the negative impact on a user based on one or more predefined rules, according to an embodiment of the disclosure.

Referring to FIG. 4A, the ML module 160 includes a historical database 161, a behavioral analyzer module 162, and a UI/UX pattern identifier 163.

In one or more embodiments, the historical database 161 is configured to store the one or more user interactions with any negatively impacting UI/UX elements, which may be used to identify and predict the negative impact of UI/UX elements on the user using the ML module 160. Examples of the one or more user interactions and associated one or more store functionalities, for example, are described in Table 2 below.

TABLE 2

| One or more user | |
|---|---|
| interactions | One or more store functionalities |
| Duration spent | an average duration spent by the |
| | user on a particular application. |
| Recommendation | a number of times the user watches a |
| | recommendation given by the application. |
| Purchase history | previously purchased history of the user |
| | from the particular application. |
| Content type | a type of content available on the |
| | application the user is using. |
| Viewing hours | how much time is spent by the |
| | user on each application |
| Video previews | a number of times the user watches a |
| | video after watching a video preview. |
| Play next | a number of times auto play happens |
| | on a particular application |
| Infinite scrolling | infinite scrolling is enabled on the |
| | particular application is enabled or not |

In one or more embodiments, the ML module 160 is configured to examine the historical database 161 to identify negative UI/UX patterns or outputs from a dataset or make decisions. The ML module 160 is further configured to interpret and accurately recognize an intent behind previously unknown phrases or word combinations by utilizing the UI/UX pattern identifier 163. The ML module 160 is further configured to detect and implement UI/UX adjustments of the at least one of one or more identified negative UI elements and one or more identified negative UX elements within the screen layout based on the identified negative UI/UX patterns. Examples of the negative UI/UX patterns are described in Table 3 below.

TABLE 3

| Type of negative | |
|---|---|
| UI/UX patterns | Description |
| Nagging | Redirection of expected functionality that |
| | persists beyond one or more interactions |
| Obstruction | Making a process more difficult than it needs to be, |
| | with the intent of dissuading certain action(s) |
| Sneaking | Attempting to hide, disguise, or delay the divulging |
| | of information that is relevant to the user. |
| Interface | Manipulation of the user interface that |
| Interference | privileges certain actions over others. |
| Force Action | Requiring the user to perform a certain action to |
| | access (or continue to access) certain functionality |

In one or more embodiments, the behavioral analyzer module 162 is configured to analyze a current user behavior associated with each of the one or more UI elements and the one or more UX elements by generating at least one of one or more feature dependency graphs and one or more interaction graphs, as described in conjunction with FIGS. 4B to 4D. The one or more feature dependency graphs and one or more interaction graphs are generated based on at least one of the generated hierarchical graph, the one or more mapped events, the one or more observable modifications, and the extracted content.

In one or more embodiments, the behavioral analyzer module 162 may include an interaction graph generator 162a, an interaction identifier 162b, and a feature dependencies graph generator 162c. The interaction graph generator 162a is configured to generate the one or more interaction graphs between each UI element, as described in conjunction with FIG. 4B. The interaction graph generator 162a is further configured to keep track of interactions between each two UI element by updating a graph. The interaction identifier 162b is configured to monitor one or more changes in the one or more interaction graphs such as an update to the application which causes the one or more interaction graphs to be updated, as described in conjunction with FIG. 4C. The feature dependencies graph generator 162c is configured to generate dependencies between different composite elements in the one or more interaction graphs that have not yet been formed, by using a graph parsing neural network, to analyze the current user behavior, as described in conjunction with FIG. 4D.

In one or more embodiments, the UI/UX pattern identifier 163 is configured to identify, based on the one or more stored user interactions and the analyzed current user behavior, the one or more patterns (negative UI/UX patterns), as described in conjunction with FIGS. 4E and 4F.

In one or more embodiments, the UI/UX pattern identifier 163 may include an NLP module 163a, a spatial analysis module 163b, and a classification module 163c. The NLP module 163a is configured to detect the extracted text that has a negative impact on the one or more UI elements, as described in conjunction with FIG. 4E. The spatial analysis module 163b is configured to detect one or more UI elements that have significant high-size differences with neighbor elements to identify the one or more patterns (negative UI/UX patterns), as described in conjunction with FIG. 4F. The classification module 163c is configured to receive an output from the NLP module 163a and the spatial analysis module 163b and classify one or more patterns (negative UI/UX patterns) using, for example, a Naïve Bayer Algorithm, as shown in Equation 1 below.

$$P ( y \vert x ) α P ( y ) * {\prod }_{i = 1}^{n} P ( {x}_{j} \vert y ) \qquad Equation 1$$

P(y|x) represents a probability of the UI element being negative given the following constraints of the UI element, and P(y) represents a prior probability of the UI element being negative. P(xⱼ|y) represents a probability of observing the output of the NLP module 163a and the spatial analysis module 163b, given UI element is negative. The classification module 163c is further configured to determine the probability of each class and then pick one UI element with a highest probability.

FIG. 4B illustrates a scenario where an interaction graph generator of a ML module 160 generates the one or more hierarchical/interaction graphs by utilizing one or more modules of an identification module, according to an embodiment of the disclosure.

Referring to FIG. 4B, the interaction graph generator 162a is configured to receive information from, for example, the Android application 304 (e.g., video application) displayed on the screen layout of the electronic device 100 by utilizing the composite element generator module 153, the event extractor module 154, and the UI element change detector module 155 and generate the one or more interaction graphs 402 between all the UI elements. Each node in the interaction graph is stored as an object that comprises data from the composite element generator module 153, the event extractor module 154, and the UI element change detector module 155, for example, as shown in Table 4. It serves a purpose of keeping track of interactions by updating the one or more interaction graphs as and when interactions update and keeping track of dependencies between the UI elements.

TABLE 4

| Node | Value |
|---|---|
| ID | Id5 |
| Layout_type | linear layout(LL) |
| Event | ACTION_SCROLL, |
| | ACTION_LONGPRESS |
| Dependencies | Id4, id3 |
| Is leaf | No |
| Text | “TV Shows” |

FIG. 4C illustrates a scenario where an interaction identifier of a ML module updates one or more generated hierarchical/interaction graphs based on one or more observable modifications and extracted content, according to an embodiment of the disclosure.

Referring to FIG. 4C, the interaction graph generator 162a is configured to receive information from the interaction graph generator 162a and the view system 152b, where the view system 152b may detect the one or more observable modifications and extracted content (e.g., swipe, click, page change, long press, and the like) at the electronic device 100. The interaction graph generator 162a is further configured to monitor, based on the received information, the one or more changes in the one or more interaction graphs 402 such as the update to the application which causes the interaction graph to be updated 403.

FIG. 4D illustrates a scenario where feature dependencies graph generator of a ML module generates one or more feature dependency graphs between one or more UI elements and one or more UX elements associated with one or more generated interaction graphs to analyze current user behavior, according to an embodiment of the disclosure.

Referring to FIG. 4D, the feature dependencies graph generator 162c is configured to receive information from the interaction graph generator 162a. The feature dependencies graph generator 162c is configured to generate dependencies between different composite elements in the one or more interaction graphs 402, as the user may not provide all dependencies, by using the graph parsing neural network to generate the dependencies 404 which may arise in a future.

FIG. 4E illustrates a block diagram of an NLP module of a ML module identifies one or more patterns associated with at least one of one or more detected UI elements and one or more detected UX elements within a screen layout having a negative impact on a user, according to an embodiment of the disclosure.

Referring to FIG. 4E, the NLP module 163a is configured to receive the extracted content from the information extractor module 156, where the content includes text information. The NLP module 163a is further configured to perform a sentiment analysis on the received text information. The NLP module 163a is further configured to classify, based on the sentiment analysis, the received text information into one of a positive, a negative, or a neutral impact on the user. The NLP module 163a is further configured to identify the one or more patterns based on a result of the classification.

In one or more embodiments, the NLP module 163a is configured to combine computational linguistics rule-based modeling of human language with statistical, machine learning models, and deep learning models, to identify the one or more patterns.

In one or more embodiments, the NLP module 163a may include a lemmatization module 163aa, a stop word module 163ab, a word embedding module 163ac, and an LSTM neural network 163ad. The lemmatization module 163aa is configured to group similar infected words. Using a WordNet lemmatizer, for example, the worlds “changes”, “changed”, “changer”, and “changing” into a single world “change”. The stop word module 163ab is configured to filter out the most frequent words in any language (such as articles, prepositions, pronouns, conjunctions, and so on) and does not provide much information to the text before or after natural language data processing. For example, “Top 10 TV shows in India Today” becomes “Top 10 TV shows India Today”. The word embedding module 163ac is configured to convert surplus vectors into a low-dimensional space while maintaining meaningful links. Word embedding is a sort of word representation that allows words with similar meanings to be represented in the same way. Word embedding is classified into two types, for example:

Word2Vec: Statistical method for effectively learning a standalone word embedding from a text corpus. Maps each word to a fixed-length vector, and these vectors may better express the similarity and analogy relationship among different words.

Doc2Vec: analyzes a group of text-like pages.

The word embedding module 163ac is configured to utilize, for example, the Word2Vec. The training process involves predicting certain words based on their surrounding words in corpora, using conditional probabilities. The Word2Vec may contain two models:

Skip-gram Model: It assumes that a word may be used to generate its surrounding words in a text sequence.

Continue bag of words (CBOW): It assumes that a center word is generated based on its surrounding context words in the text sequence, by performing one or more operations, which are given below. Input to the model is one-hot encoded vector and output is also a vector. The model trains two types of weight matrices U and V.

Generate one hot word vector (x^{(c-m)}, . . . , x^{(c-1)}, x^{(c+1)}, . . . , x^{(c+m)}) for input context of size m.

Generate embedded word vector for context (v_{c-m}=Vx^{(c-m)}, v_{c-m+1}=Vx^{(c-m+1)}, . . . , v_{c+m}=Vx^{(c+m)})

Average these vectors to get

$${v}^{′} = \frac{v c - m + v c - m + 1 + … + v c + m}{2 m}$$

Generate a score vector z=Uv′
Turn the scores into probability y′=softmax(z)

Probability generates y′, to match the true probability y, which also happens to be the one hot vector of the actual word.

To calculate the loss function, the model may use cross entropy, a popular choice of distance/loss measure, H(y′,y)=Σⱼ₌₁^{|V|}yj Log(y′j).

The LSTM neural network 163ad is configured to recognize text that has a negative impact on the user. It is a sort of neural network design that may teach long-term dependencies. The LSTM network is made up of numerous interconnected layers (i.e., a LSTM architecture 405), such as cellular state, input-output gate layer, update on cell status, and data output.

Cellular state: The cellular state is a horizontal line that runs through the top of the LSTM architecture 405. It is the “memory” of the network that is updated throughout the entire sequence. The cellular state may be updated, added to, or removed information from the cellular state via the various gates in the LSTM architecture 405.

Input gate layer: The input gate layer determines which information from the input may be used to update the cell state. It takes the input and the previous hidden state and decides which values to let through.

Output gate layer: The output gate layer determines which part of the cellular state may be output as the final prediction. It takes the input and the previous hidden state and determines which values of the cell state should be passed on to the output.

FIG. 4F illustrates a scenario where a spatial analysis module of a ML module identifies one or more patterns associated with at least one of one or more detected UI elements and one or more detected UX elements within a screen layout having a negative impact on a user, according to an embodiment of the disclosure.

Referring to FIG. 4F, the spatial analysis module 163b is configured to perform a spatial analysis on one or more segments associated with the screen layout, for example, the one or more segments 406 of the video application, each with its own identity (e.g., “romantic” as Id-1, “comedy” as Id-2, “Bollywood” as Id-3, and the like). The spatial analysis module 163b is further configured to determine one or more neighbor segments around a given segment (e.g., “comedy”) and determine a relative size of the given segment in comparison to a size of one or more neighbor segments (e.g., “romantic”, “Bollywood”, and so on) by performing one or more actions described below.

For the given segment determine, by the spatial analysis module 163b, the neighborhood area with adding proximity factor to segment boundaries.

The proximity factor is determined as a very small percentage (e.g., ≈5%) of the segment size, which is derived empirically.

Any segment whose boundaries intersect with the boundary of the neighborhood, that segment is then considered a neighbor of the current segment being analyzed.

The spatial analysis module 163b is further configured to determine a relative width and height of the segment with respect to the height and width of the one or more neighbor segments 407.

Each segment's width and height are divided by the maximum width and height found in the neighborhood associated with the one or more neighbor segments.

In one or more embodiments, the spatial analysis module 163b is further configured to identify, based on the one or more performed actions, the one or more patterns having the negative impact on the user.

FIG. 5 illustrates a block diagram of a display controller module of an electronic device to determine one or more UI elements that have to be placed on top of at least one of one or more identified negative UI elements and one or more identified negative UX elements within the screen layout according to an embodiment of the disclosure.

Referring to FIG. 5, the display controller module 170 may include an overlay module 170a and an update database and change UI visibility module 170b.

In one or more embodiments, the overlay module 170a is configured to generate a new window and add the generated new window to a list of windows associated with the Window manager 152e, the Window manager 152e may then determine a position of the new window and draw the new window on the screen layout.

The new window is often placed on top of the existing content on the screen layout, allowing the overlay module 170a to create a customized view over the at least one of one or more identified negative UI elements and one or more identified negative UX elements. For example, the Window manager 152e utilize a window type to decide where the new window is supposed to be positioned in relation to other windows, as well as whether the new window overlap other windows or the system UI, where, for example, “WindowManager.LayoutParams” have been set to “type_application_overlay”.

In one or more embodiments, an overlay is an additional layer that is drawn on top of a view (“host view”) after all other content in that view. To implement an overlay in Android, for example, the overlay module 170a is configured to utilize a “viewgroupoverlay” class. The “viewgroupoverlay” is a subclass of “viewoverlay” that adds an ability to manage views for overlays on ViewGroups to ViewOverlay's drawable functionality, for example, as described in Table 5 below.

TABLE 5

| | |
|---|---|
| public ViewGroupOverlay | Returns the ViewGroupOverlay for this |
| getOverlay ( ) | view group, creating it if it does not yet |
| | exist. |
| public void add | Adds a View to the overlay. The bounds |
| (Drawable drawable) | of the added view should be relative to |
| | the host view. |
| public void remove | Removes the specified View from the |
| (Drawable drawable) | overlay. |

Consider an example scenario where the user is using the electronic device 100 to watch a video. As the video nears its end, a pop-up notification appears 501, suggesting another video to watch next, like “next video starting in 7 seconds”. This is a common tactic used in the video applications to keep users engaged. This common tactic may sometimes use visual elements like colors and shading to grab the user's attention, and this may potentially have the negative impact on the user's mental well-being. In response to this example scenario, the overlay module 170a may determine the one or more UI elements (e.g., new window) that have to be placed on top (overlaying) of at least one of one or more identified negative UI elements and one or more identified negative UX elements within the screen layout 502.

In one or more embodiments, after overlaying, the update database and change UI visibility module 170b is configured to receive feedback from the user in response to the determining of the one or more UI elements that have to be placed on top of the at least one of one or more identified negative UI elements and one or more identified negative UX elements. The update database and change UI visibility module 170b is further configured to update, using a reinforcement learning technique, one or more parameters associated with the identification module 150 based on the feedback. For example, if the identification module 150 is not accurately identifying certain inputs, the reinforcement learning technique may be used to adjust the one or more parameters and improve overall performance. The update database and change UI visibility module 170b is further configured to personalize UI/UX elements based on at least one of one or more identified negative UI elements, one or more identified negative UX elements, and the one or more updated parameters.

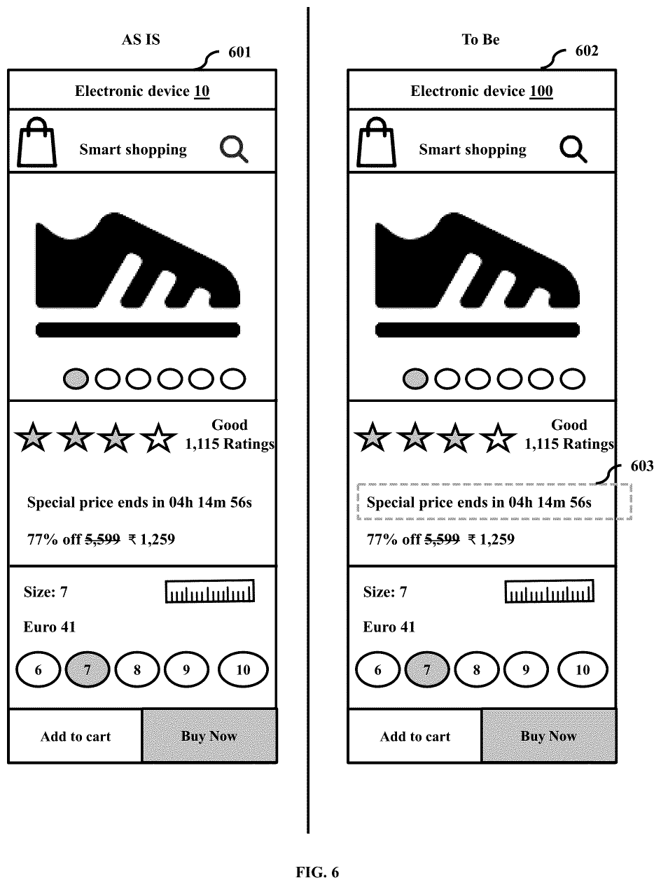

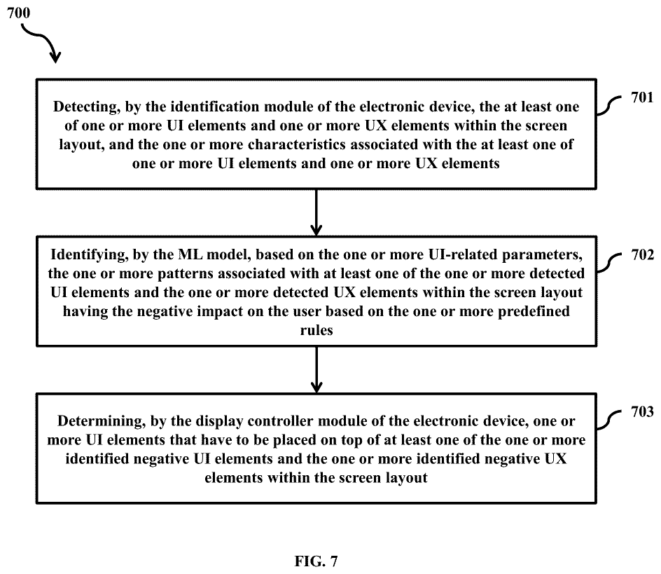

FIG. 6 illustrates a comparison scenario between existing system and disclosed system (e.g., system 101) to identify one or more patterns within the screen layout of the electronic device having the negative impact on a user of an electronic device, according to an embodiment of the disclosure.

Referring to FIG. 6, consider an example scenario where the user is using the electronic device 100 to buy shoes via a shopping application. In an existing system 601, an existing electronic device 10 displays a notification suggesting a special deal, such as “Special price ends in 04 h 14 m 56 s”. This is a common tactic used in shopping applications to compel users to buy. This common tactic goes unnoticed by the existing electronic device 10, which might have a detrimental influence on the user. To address or mitigate this consequence, a disclosed system 602 is configured to perform one or more operations by utilizing the dark pattern identifier module 140 to identify one or more patterns (e.g., Special price ends in 04 h 14 m 56 s) 603 within the screen layout of the electronic device 100 having the negative impact on the user of the electronic device 100. As a result, the disclosed system 602 has advantages over the existing system 601, which enhances the user experience, and establishes a balance between keeping users engaged and ensures a positive experience.

FIG. 7 is a flow diagram illustrating a method for identifying one or more patterns within a screen layout of an electronic device having the negative impact on a user of the electronic device, according to an embodiment of the disclosure.

Referring to FIG. 7, at operation 701, a method 700 includes detecting, by the identification module 150 of the electronic device 100, the at least one of one or more UI elements and one or more UX elements within the screen layout, and the one or more characteristics associated with the at least one of one or more UI elements and one or more UX elements, as described in conjunction with FIGS. 3A to 3C and 6.

At operation 702, the method 700 includes identifying, by the ML module 160 of the electronic device 100, based on the one or more UI-related parameters, the one or more patterns associated with at least one of the one or more detected UI elements and the one or more detected UX elements within the screen layout having the negative impact on the user based on the one or more predefined rules, as described in conjunction with FIGS. 4A to 4F and 6.

At operation 703, the method 700 includes determining, by the display controller module 170 of the electronic device 100, one or more UI elements that have to be placed on top of at least one of the one or more identified negative UI elements and the one or more identified negative UX elements within the screen layout, as described in conjunction with FIGS. 5 and 6.

The various actions, acts, blocks, steps, or the like in the flow diagrams may be performed in the order presented, in a different order, or simultaneously. Further, in some embodiments, some of the actions, acts, blocks, steps, or the like may be omitted, added, modified, skipped, or the like without departing from the scope of the disclosure.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein may be implemented using at least one hardware device and performing network management functions to control the elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for identifying one or more patterns within a screen layout of an electronic device having a negative impact on a user of the electronic device, the method comprising:
detecting, by an identification module of the electronic device, at least one of one or more user interface (UI) elements and one or more user experience (UX) elements within the screen layout, and one or more characteristics associated with the at least one of one or more UI elements and one or more UX elements;
identifying, by a machine learning (ML) module, based on one or more UI-related parameters, the one or more patterns associated with at least one of one or more detected UI elements and one or more detected UX elements within the screen layout having the negative impact on the user based on one or more predefined rules; and
determining, by a display controller module of the electronic device (100), one or more UI elements that have to be placed on top of at least one of one or more identified negative UI elements and one or more identified negative UX elements within the screen layout.

2. The method of claim 1, further comprising:
receiving feedback from the user in response to the determining of the one or more UI elements that have to be placed on top of the at least one of one or more identified negative UI elements and one or more identified negative UX elements;
updating, using a reinforcement learning technique, one or more parameters associated with the identification module based on the feedback; and
personalizing UI/UX elements based on at least one of one or more identified negative UI elements, one or more identified negative UX elements, and the one or more updated parameters.

3. The method of claim 1, wherein the detecting of the at least one of the one or more UI elements and the one or more UX elements within the screen layout comprises:
detecting, using at least one of a user agent string and system application programming interfaces (APIs), platform information on which at least one application of the electronic device is running, the platform information including a type of operating system (OS), a version of the OS, and a hardware architecture;
utilizing one or more application framework modules associated with the electronic device to detect at least one of the one or more UI elements and the one or more UX elements within the screen layout; and
detecting, based on the detected platform information, and the one or more utilized application framework modules, at least one of the one or more UI elements, and the one or more UX elements within the screen layout.

4. The method of claim 1, wherein the detecting of the one or more characteristics associated with the at least one of one or more UI elements and one or more UX elements comprises:
generating, by utilizing one or more application framework modules, a hierarchical graph associated with the at least one of one or more UI elements and one or more UX elements;
mapping, upon detecting one or more user interactions, one or more events with the at least one of one or more UI elements and one or more UX elements by utilizing one or more application framework modules, the one or more events comprising a scroll event, a long press event, a short press event, and a click event;
monitoring, upon detecting one or more user interactions, one or more observable modifications associated with the at least one of one or more UI elements and one or more UX elements; and
extracting content associated with the at least one of one or more UI elements and one or more UX elements, the content comprising at least one of text information, image information, and icon information.

5. The method of claim 4,
wherein the identifying of the one or more patterns based on the one or more based on predefined rules comprises:
storing, by a historical database of the ML module, the one or more user interactions;
analyzing, by a behavioral analyzer module of the ML module, a current user behavior associated with each of the one or more UI elements and the one or more UX elements by generating at least one of one or more feature dependency graphs and one or more interaction graphs; and
identifying, by a UI/UX pattern identifier of the ML module, based on the one or more stored user interactions and the analyzed current user behavior, the one or more patterns, and
wherein the UI/UX pattern identifier comprises a natural language processing (NLP) module, a spatial analysis module, and a classification module.

6. The method of claim 5, wherein the at least one of one or more feature dependency graphs and one or more interaction graphs are generated based on at least one of the generated hierarchical graph, the one or more mapped events, the one or more observable modifications, and the extracted content.

7. The method of claim 5,
wherein each of the one or more feature dependency graphs and the one or more interaction graphs comprises a plurality of nodes, and
wherein each of the plurality of nodes comprises element information along with a specific value.

8. The method of claim 5, further comprising:
updating, based on the one or more observable modifications and the extracted content, the one or more interaction graphs.

9. The method of claim 5, wherein the generating of the one or more feature dependency graphs comprises:
generating, using a graph parsing neural network, the one or more feature dependency graphs between the one or more UI elements and the one or more UX elements associated with the one or more generated interaction graphs to analyze the current user behavior.

10. The method of claim 5, further comprising:
performing, by the NLP module, one or more actions to identify the one or more patterns,
wherein the performing of the one or more actions comprises:
receiving the extracted content from the identification module, the content comprising text information;
performing a sentiment analysis on the received text information;
classifying, based on the sentiment analysis, the received text information into one of a positive, a negative, or a neutral impact on the user; and
identifying the one or more patterns based on a result of the classification.

11. The method of claim 5, further comprising:
performing, by the spatial analysis module, one or more actions to identify the one or more patterns,
wherein performing the one or more actions comprises:
performing the one or more actions comprises determining a height and a width of each of the at least one of one or more detected UI elements and one or more detected UX elements within the screen layout; and
identifying, based on the one or more performed actions, the one or more patterns having the negative impact on the user.

12. The method of claim 5, further comprising:
performing, by the classification module, one or more actions to identify the one or more patterns,
wherein performing the one or more actions comprises:
identifying, using naïve bayes mechanism, the one or more patterns upon receiving an output from the NLP module and the spatial analysis module.

13. The method of claim 1,
wherein the one or more UI-related parameters comprise at least one of a historical behavioral pattern of the user and a current behavioral pattern of the user associated with a single or multi-program scenario associated with the electronic device, and
wherein the multi-program scenario comprises one or more programs running on cross platforms.

14. The method of claim 1, wherein the one or more detected UI elements and the one or more detected UX elements, along with the one or more characteristics, are dynamically or statically displayed over the UI of an active program or a background program associated with the electronic device.

15. The method of claim 1, wherein the one or more characteristics associated with the at least one of one or more UI elements and one or more UX elements comprises at least one of feature information, position information, and functionality information.

16. A system for identifying one or more patterns within a screen layout of an electronic device having a negative impact on a user of an electronic device, the system comprising:
memory;
at least one processor;
a communicator; and
a dark pattern identifier module, operably connected to the memory, the at least one processor, and the communicator,
wherein the dark pattern identifier module executing by the at least one processor, instructions stored in the memory, is configured to:
detect at least one of one or more user interface (UI) elements and one or more user experience (UX) elements within the screen layout, and one or more characteristics associated with the at least one of one or more UI elements and one or more UX elements,
identify based on one or more UI-related parameters, the one or more patterns associated with at least one of one or more detected UI elements and one or more detected UX elements within the screen layout having the negative impact on the user based on one or more predefined rules, and
determine one or more UI elements that have to be placed on top of at least one of one or more identified negative UI elements and one or more identified negative UX elements within the screen layout.

17. The system of claim 16, wherein the dark pattern identifier module executing by the at least one processor, the instructions stored in the memory, is further configured to:
receive feedback from the user in response to the determining of the one or more UI elements that have to be placed on top of the at least one of one or more identified negative UI elements and one or more identified negative UX elements;
update, using a reinforcement learning technique, one or more parameters associated with the identification module based on the feedback; and
personalize UI/UX elements based on at least one of one or more identified negative UI elements, one or more identified negative UX elements, and the one or more updated parameters.

18. The system of claim 16, wherein the detecting of the at least one of the one or more UI elements and the one or more UX elements within the screen layout, the dark pattern identifier module executing by the at least one processor, the instructions stored in the memory, is further configured to:
detect, using at least one of a user agent string and system application programming interfaces (APIs), platform information on which at least one application of the electronic device is running, the platform information including a type of operating system (OS), a version of the OS, and a hardware architecture;
utilize one or more application framework modules associated with the electronic device to detect at least one of the one or more UI elements and the one or more UX elements within the screen layout; and
detect, based on the detected platform information, and the one or more utilized application framework modules, at least one of the one or more UI elements, and the one or more UX elements within the screen layout.

19. The system of claim 16, wherein the detecting of the one or more characteristics associated with the at least one of one or more UI elements and one or more UX elements, the dark pattern identifier module executing by the at least one processor, the instructions stored in the memory, is further configured to:
generate, by utilizing one or more application framework modules, a hierarchical graph associated with the at least one of one or more UI elements and one or more UX elements;
map, upon detecting one or more user interactions, one or more events with the at least one of one or more UI elements and one or more UX elements by utilizing one or more application framework modules, the one or more events comprising a scroll event, a long press event, a short press event, and a click event;
monitor, upon detecting one or more user interactions, one or more observable modifications associated with the at least one of one or more UI elements and one or more UX elements; and
extract content associated with the at least one of one or more UI elements and one or more UX elements, the content comprising at least one of text information, image information, and icon information.

20. A non-transitory computer-readable storage, storing thereon instructions that when executed by at least one processor, perform a method for identifying one or more patterns within a screen layout of an electronic device having a negative impact on a user of the electronic device, the method comprising:
detecting, by an identification module of the electronic device, at least one of one or more user interface (UI) elements and one or more user experience (UX) elements within the screen layout, and one or more characteristics associated with the at least one of one or more UI elements and one or more UX elements;
identifying, by a machine learning (ML) module, based on one or more UI-related parameters, the one or more patterns associated with at least one of one or more detected UI elements and one or more detected UX elements within the screen layout having the negative impact on the user based on one or more predefined rules; and
determining, by a display controller module of the electronic device (100), one or more UI elements that have to be placed on top of at least one of one or more identified negative UI elements and one or more identified negative UX elements within the screen layout.
